(19) United States
(12) Patent Application Publication
(10) Pub. No.: US 2005/0127984 A1
(43) Pub. Date: Jun. 16, 2005

(54) Power supply circuit having a plurality of voltage conversion circuits

(75) Inventor: Nobuyuki Ohtaka, Kadoma-Shi (JP)

Correspondence Address: OSHA & MAY L.L.P., 1221 MCKINNEY STREET, SUITE 2800, HOUSTON, TX, 77010, US

(73) Assignee: Sanyo Electric Co., Ltd., Osaka (JP)

(21) Appl. No.: 11/008,884

(22) Filed: Dec. 10, 2004

(30) Foreign Application Priority Data
Dec. 11, 2003 (JP) JP2003-413708

(51) Int. Cl. G05F 1/10

(52) U.S. Cl. 327/536

(57) ABSTRACT

The output voltage of a charge pump 10 is monitored by a voltage monitoring circuit. The operating current of a series regulator is restricted when the output voltage of the charge pump falls below a predetermined value. A power supply circuit is provided that is capable of effectively eliminating the decline in the output voltage of the charge pump.

### CROSS-REFERENCE TO RELATED APPLICATION

The entire disclosure of Japanese Application No. 2003-413708 including specification, claims, drawings and abstract is incorporated herein by reference.

### BACKGROUND OF THE INVENTION

1. Field of the Invention

The present invention relates to a power supply circuit for providing as its output the output of a charge pump via a plurality of voltage conversion circuits.

2. Description of the Related Art

Voltages other than the voltage supplied from the power supply have become necessary in electrical circuits in some instances. In semiconductor integrated circuits (e.g., LSI, IC) operating on battery power, for example, a voltage higher than the battery power or a negative power supply adapted to obtain the dynamic range may become necessary. A switching regulator is employed in such a case. The switching regulator is a circuit that uses a coil to step up (or step down) the voltage, thus providing a desired voltage.

On the other hand, the charge pump is coming into wider use to replace the switching regulator. The charge pump is a circuit that shifts the voltage charged in a capacitor to provide a desired voltage.

FIG. 1 shows an example of the charge pump. In this example, two p-channel transistors Q1 and Q2 are connected in series between a supply voltage Vcc and the output end. One end of a capacitor C1 is connected to the connection point between the transistors Q1 and Q2. To the other end of the capacitor C1, the supply voltage Vcc and a ground voltage GND are alternately supplied via an inverter INV1. To the output end, one end of a capacitor C2, whose other end is connected to ground, is connected.

In such a circuit, with one end of the capacitor C1 pulled to the ground voltage, the transistor Q1 is turned on and the transistor Q2 turned off to charge the capacitor C1 with the Vcc voltage. Next, the transistor Q1 is turned off and the transistor Q2 turned on to pull the other end of the capacitor C1 to Vcc. The one end of the capacitor C1 becomes 2 Vcc, and this voltage is charged in the capacitor C2. As a result, the output end voltage becomes 2 Vcc. It is to be noted that, in FIG. 1, a control voltage is supplied to the transistor Q1 and is inverted by an inverter INV2 to be supplied to the gate of the transistor Q2. Diodes may be used in place of the transistors Q1 and Q2. While MOSFETs are used as transistors as an example, the present invention is not limited thereto and any other types of transistors may be used.

Such a circuit can double the supply voltage Vcc. Besides, this circuit does not require any coil, thus offering the advantage that the circuit can be simplified.

The voltage obtained from the switching regulator or charge pump is regularly not supplied as is to ICs. Instead, the voltage is regulated by a series regulator to a constant voltage before being supplied. The series regulator is configured, for example, as shown in FIG. 2.

One end of a p-channel transistor Q3 is connected to the output end of the charge pump. The other end of the p-channel transistor Q3 is connected to ground via resistors R1 and R2. The connection point between the resistors R1 and R2 is conected to the non-inverting input terminal of a comparator COMP1, whereas a reference voltage Vref1 is fed to the inverting input terminal of the comparator COMP1. The output of the comparator COMP1 is fed to the gate of the transistor Q3. The connection point between the transistor Q3 and the resistor R1 is connected to the output end of the series regulator. To this output end, one end of a capacitor C3, whose other end is connected to ground, is also connected.

The comparator COMP1 makes the voltage at the connection point between the resistors R1 and R2 Vref1. As a result, the voltage Vref1×(R1+R2)/R1 can be stably obtained at the output end.

Here, the switching regulator has a large output current capacity. However, the charge pump has a smaller current capacity than the switching regulator. FIG. 3 shows an example of the relationship between the output current (load current) and the output voltage of the charge pump. As shown in the figure, the larger the load current, the smaller the output voltage in the charge pump.

In the series regulator, on the other hand, the comparator operates to its full capability at startup in an attempt to raise the output voltage, thus causing a large current to flow. The large current flows through the series regulator at startup as shown by the broken line in FIG. 4. This current causes the output voltage to rise steeply as shown by the solid line. As a result, the predetermined voltage is obtained.

For this reason, if a series regulator 12 is connected to the output of a charge pump 10 as shown in FIG. 5 and started up, the output voltage of the charge pump 10 declines considerably as shown in FIG. 6.

Therefore, if the series regulator is started up while the output of the charge pump is used in another circuit, the supply voltage to the other circuit declines considerably. As a result, the other circuit may become unable to operate properly.

The startup of the series regulator 12 is considered, for instance, in a circuit having two series regulators 12 and 14 connected to the output of the charge pump 10 as shown in FIG. 7, while the series regulator 14 is operating. In this case, the output voltage (output 1) of the series regulator 12 rises as the series regulator 12 starts up. At this moment, a large current flows, causing the output voltage of the charge pump 10 to decline considerably. As a result, the output voltage (output 2) of the series regulator 14 also declines considerably.

It is to be noted that the output voltage of the switching regulator does not decline much because of the high current capacity thereof as shown in FIG. 9 even if the series regulator, connected to the succeeding stage of the switching regulator, is started up. As a result, serious problems are unlikely. The aforementioned problem has not been encountered in the conventional circuit using the switching regulator.

### SUMMARY OF THE INVENTION

Thus, according to a major aspect of the present invention there is provided a power supply circuit comprising a charge pump operable to charge a capacitor to a predetermined voltage and thereafter vary the voltage at one end of the charged capacitor to produce at the other end thereof a voltage shifted in response to the variation, and a voltage conversion circuit operable to convert the output of the charge pump to a voltage based on the comparison with a predetermined reference voltage, the voltage conversion circuit outputting the converted voltage as the supply voltage of other circuit, wherein the operating current of the voltage conversion circuit is restricted so that the output voltage of the charge pump is prevented from varying over a predetermined value.

### BRIEF DESCRIPTION OF THE DRAWINGS

The above and other aspects, features and advantages of the present invention will become more apparent from the following detailed description when taken in conjunction with the accompanying drawings, in which:

FIG. 1 illustrates a configuration example of a charge pump according to the background technology;

FIG. 2 illustrates a configuration example of a series regulator according to the background technology;

FIG. 3 illustrates the relationship between the load current and the output voltage of the charge pump according to the background technology;

FIG. 4 illustrates the startup current and the output voltage of the series regulator according to the background technology;

FIG. 5 illustrates a system configuration consisting of the charge pump and the series regulator according to the background technology;

FIG. 6 illustrates the output voltage of the charge pump at startup of the series regulator according to the background technology;

FIG. 7 illustrates a system configuration consisting of the charge pump and a plurality of the series regulators according to the background technology;

FIG. 8 illustrates the output voltage of the charge pump at startup of the series regulator in the configuration of FIG. 7;

FIG. 9 illustrates the output voltage of a switching regulator at startup of the series regulator according to the background technology;

FIG. 10 illustrates a system configuration according to an embodiment;

FIG. 11 illustrates the output voltage of the charge pump at startup of the series regulator;

FIG. 12 illustrates a system configuration consisting of the charge pump and a plurality of the series regulators according to the embodiment;

FIG. 13 illustrates a system configuration consisting of the charge pump having a plurality of outputs and the series regulator according to the embodiment;

FIG. 14 illustrates the plurality of the output voltages of the charge pump at startup of the series regulator;

FIG. 15 illustrates the output voltages of the charge pump and the series regulator under an overload condition;

FIG. 16 illustrates a configuration according to the embodiment adapted to control the operation of a voltage monitoring circuit with a switch;

FIG. 17 illustrates a configuration according to the embodiment adapted to control the operation of the voltage monitoring circuit with a timer;

FIG. 18 illustrates a configuration of the series regulator according to the embodiment; and

FIG. 19 illustrates a circuit configuration according to the embodiment adapted to control the output of the voltage monitoring circuit.

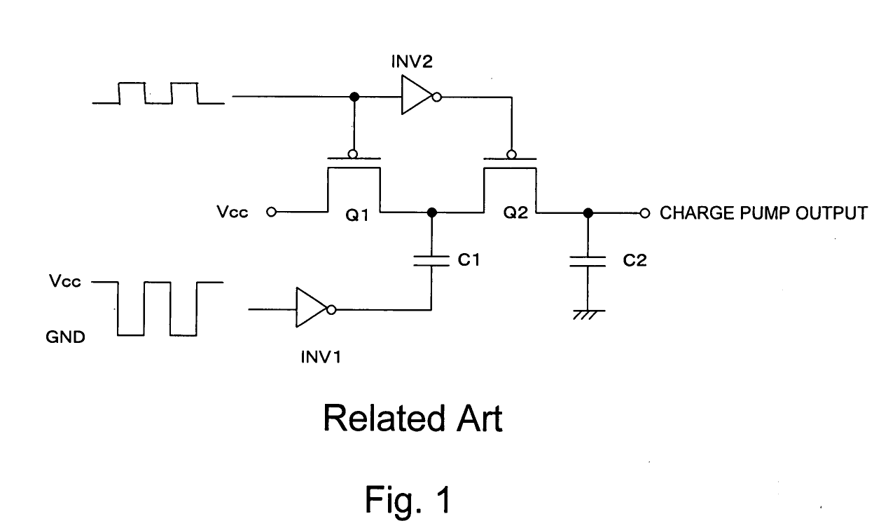

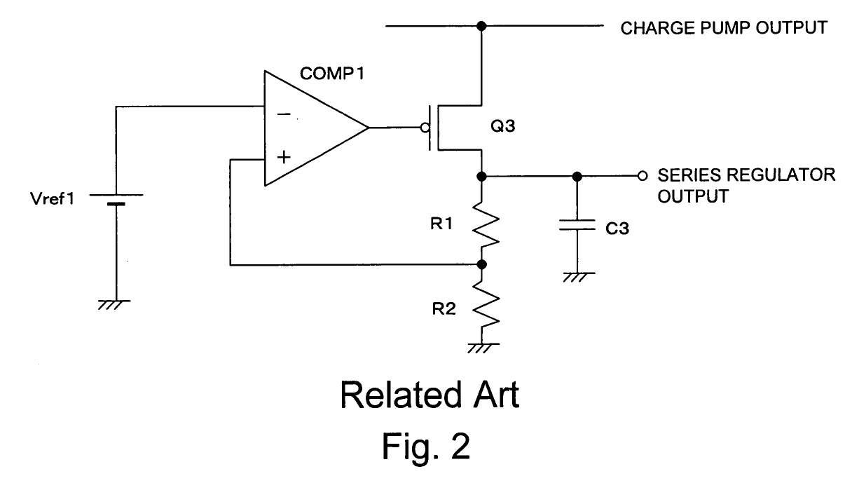

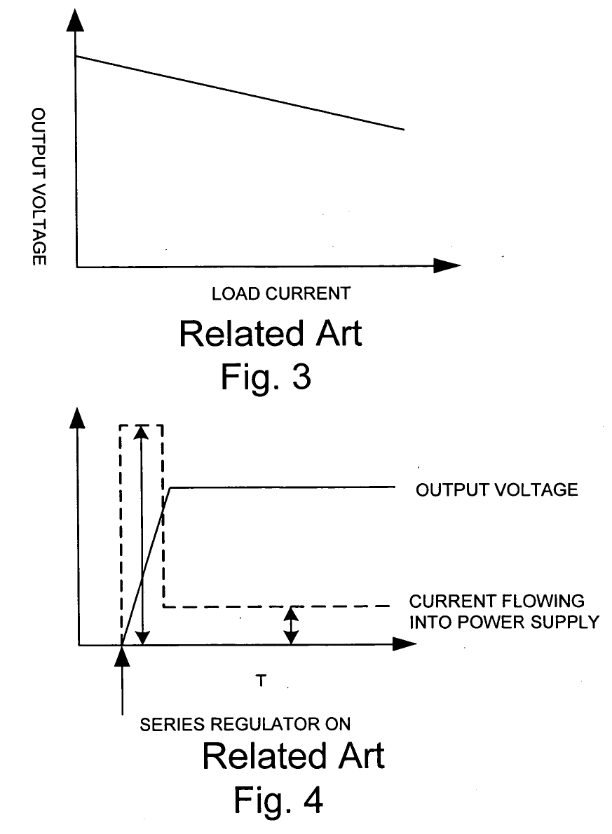

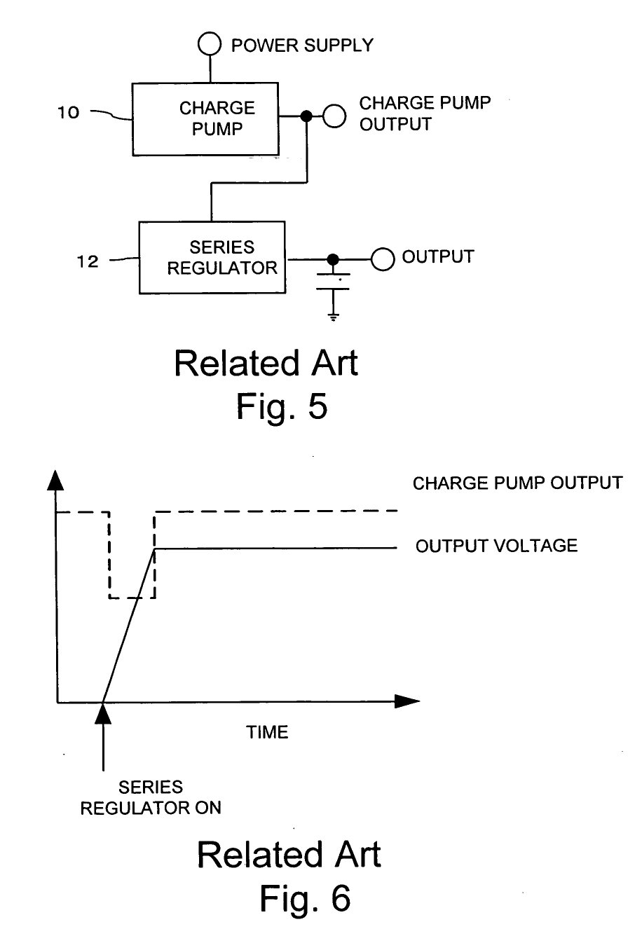

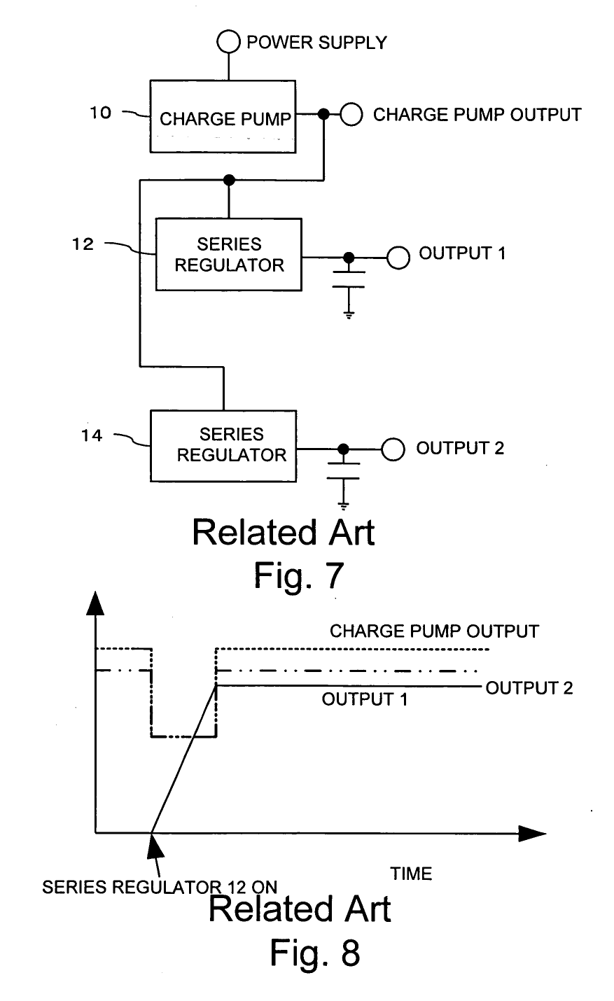

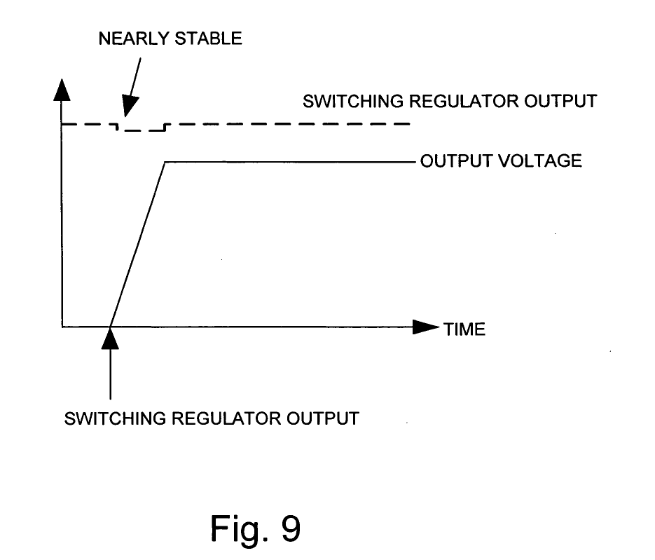

### DESCRIPTION OF THE PREFERRED EMBODIMENT

An embodiment of the present invention will now be described with reference to the accompanying drawings.

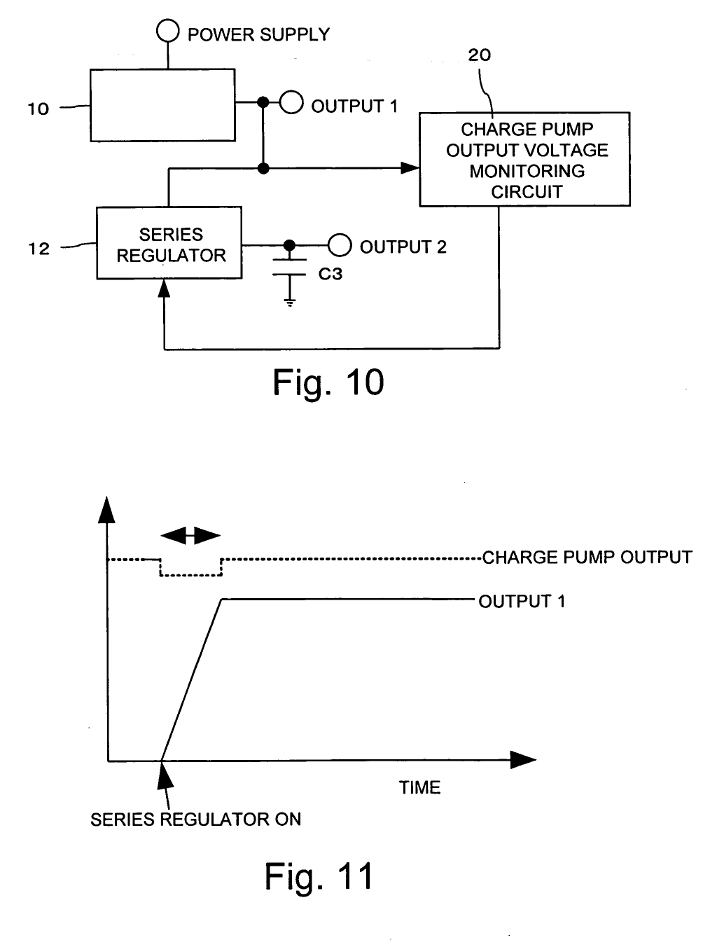

FIG. 10 illustrates a configuration according to the embodiment. The series regulator 12 is connected to the output of the charge pump 10. A voltage monitoring circuit 20 is provided to monitor the output of the charge pump 10. This voltage monitoring circuit 20 controls the operation of the series regulator 12. That is, the voltage monitoring circuit 20 controls the operation of the series regulator 12 to restrict the amount of current flowing through the series regulator 12 in the event of a decline in the output voltage of the charge pump more than a predetermined value. Therefore, the output voltage of the charge pump 10 does not vary significantly.

As described above, if the output voltage of the charge pump 10 declines below a set voltage as a result of increased amount of current flowing from the charge pump 10 into the series regulator 12, the voltage monitoring circuit 20 restricts the current flowing into the series regulator 12 from the charge pump 10, thus preventing the decline in the output voltage of the charge pump 10. This also suppresses variations in the output voltage of the charge pump at the startup of the series regulator 12 as shown in FIG. 11. Consequently, the output voltage of the charge pump can be used as a stable voltage supply. This makes it possible to prevent adverse effect on another circuit operating on the output voltage of the charge pump 10.

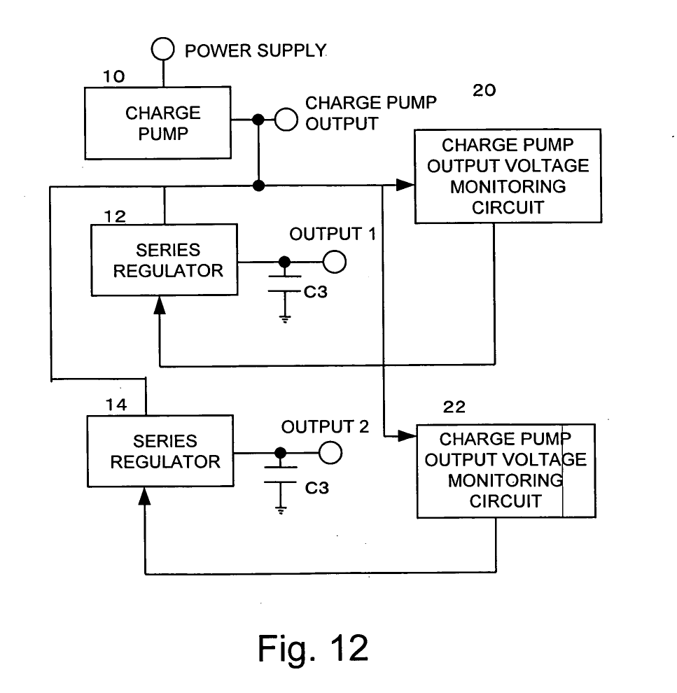

FIG. 12 is another configuration example. In this example, the series regulator 14 and a voltage monitoring circuit 22 are provided in addition to the series regulator 12 and the voltage monitoring circuit 20. The voltage monitoring circuit 20 controls the current in the series regulator 12, whereas the voltage monitoring circuit 22 controls the current in the series regulator 14. This makes it possible to stabilize the output voltages of the charge pump 10 and the series regulators 12 and 14.

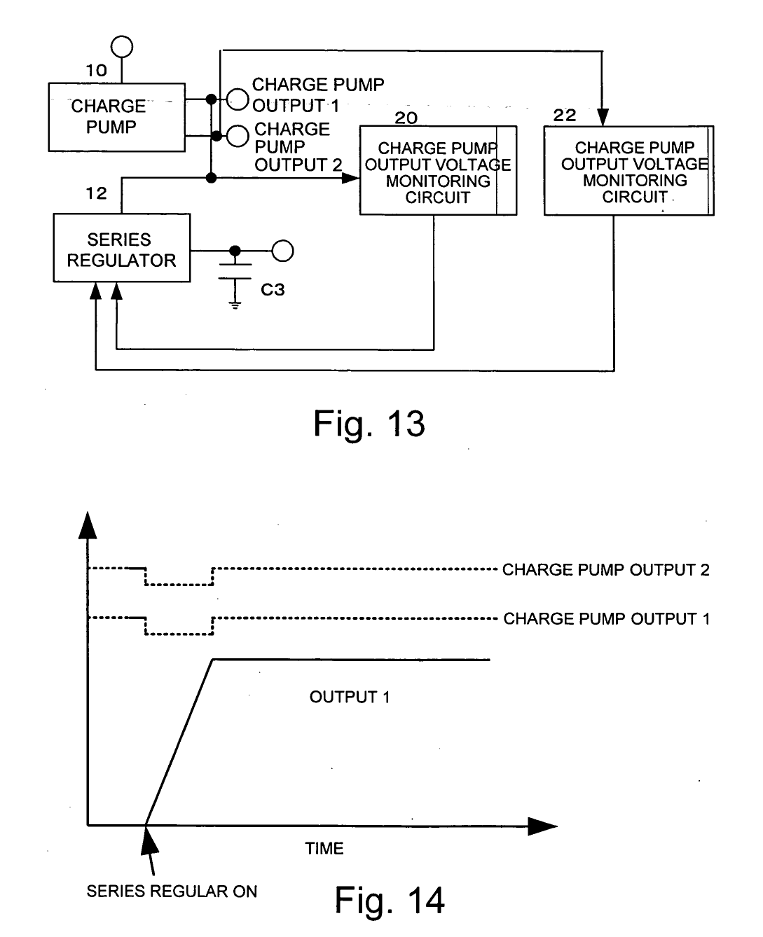

FIG. 13 shows the charge pump 10 with a plurality of outputs. That is, when the charge pump 10 has a multi-stage configuration, the voltage can be stepped up (or down) in succession. As a result, a plurality of outputs can be retrieved. In this case, the plurality of outputs are monitored to produce the output voltages in a stable manner. That is, outputs 1 and 2 of the charge pump 10 are monitored respectively by the voltage monitoring circuits 20 and 22. The current in the series regulator 12 is restricted in response to the results of the monitoring. In particular, when one of the series regulators starts up, the current in that series regulator is restricted. This suppresses variations in the output voltage of the other series regulator.

Consequently, a significant voltage drop can be prevented at both of the outputs (outputs 1 and 2) of the charge pump 10 as shown in FIG. 14.

As described in the above configuration examples, if the output voltage of the charge pump is monitored, the performance of the series regulator is determined by the performance of the charge pump. This also provides the advantage of eliminating the need for an output current limiting circuit that would normally be required.

While in the above example the output voltage of the charge pump 10 is monitored by the voltage monitoring circuits 20 and 22, the halfway voltage of the charge pump 10 can also be monitored. The outputs of the series regulators 12 and 14, while in operation, may be monitored as well. The reason for this is that since these voltages are relevant to and change in the same manner as the output voltage of the charge pump 10, monitoring any of these voltages translates into monitoring of the output voltage of the charge pump 10.

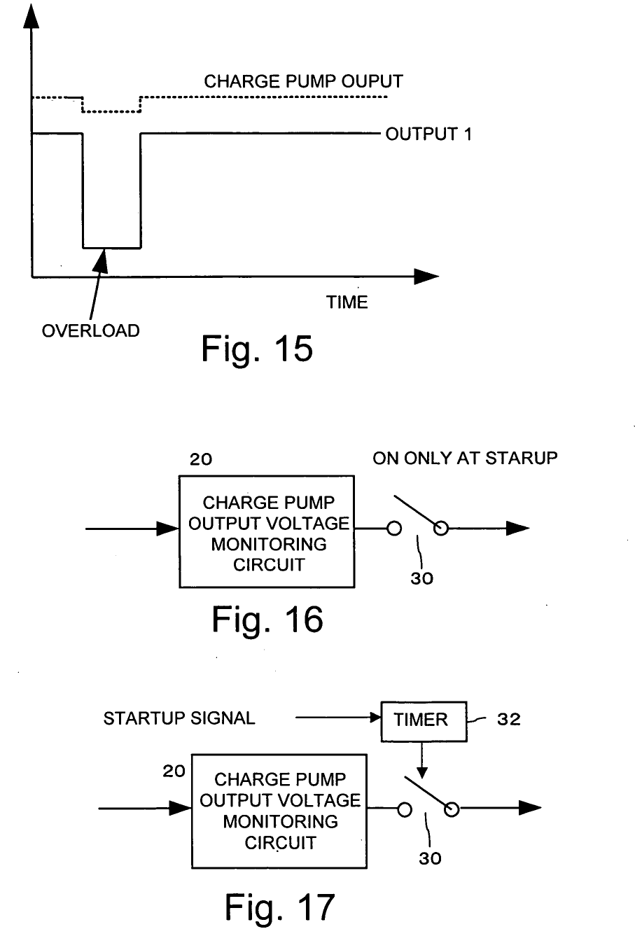

Here, when the monitoring is carried out, the amounts of current in the series regulators 12 and 14 are always restricted in the event of a decline in the output voltage of the charge pump 10. Therefore, if the load of the series regulator 12 or 14 changes even momentarily, the performance of the series regulator 12 is restricted. Then, the output voltages of the series regulators 12 and 14 significantly decline as shown in FIG. 15 even if the series regulators 12 and 14 have leeway in the load driving capacity. In particular, this operation occurs even in the event of a mustache-like short-period load current pulse and renders the output voltages of the series regulator 12 and 14 unstable.

For this reason, a switch 30 is provided as shown in FIG. 16 to restrict the output of the voltage monitoring circuit 20. The switch 30 is turned on only at startup so that the monitoring operation is carried out only at the startup of the series regulators 12 and 14. The switching prevents the current restriction in the series regulators 12 and 14 when a mustache-like short-period load current pulse appears in the output voltage of the charge pump 10. As a result, the output voltages of the series regulators 12 and 14 can be stabilized.

It is to be noted that the comparator COMP1 of the series regulator 12 is configured with an op-amp. The comparator COMP1 normally keeps the built-in constant current source off remaining inoperative. Here, it suffices to use a startup signal, adapted to turn on the constant current source, to turn on the switch 30 and then turn off the switch 30 in a predetermined period of time.

To proceed with the monitoring only at startup, a timer 32 may be provided as shown in FIG. 17 to allow the operation of the voltage monitoring circuit 20 only for a predetermined period of time from startup. The timer 32 receives a startup signal indicating the startup of the series regulator to turn on the switch 30 only for a predetermined period of time from when the startup signal is input.

Here, other methods may be used in place of the timer 32. Such methods include stopping the monitoring by the voltage monitoring circuit 20 when the output voltage thereof reaches a certain voltage based on the judgment that the series regulator 12 has started up and halting the voltage monitoring circuit in a predetermined period of time after the output voltage of the series regulator 12 reaches a certain voltage based on the judgment that the series regulator has started up.

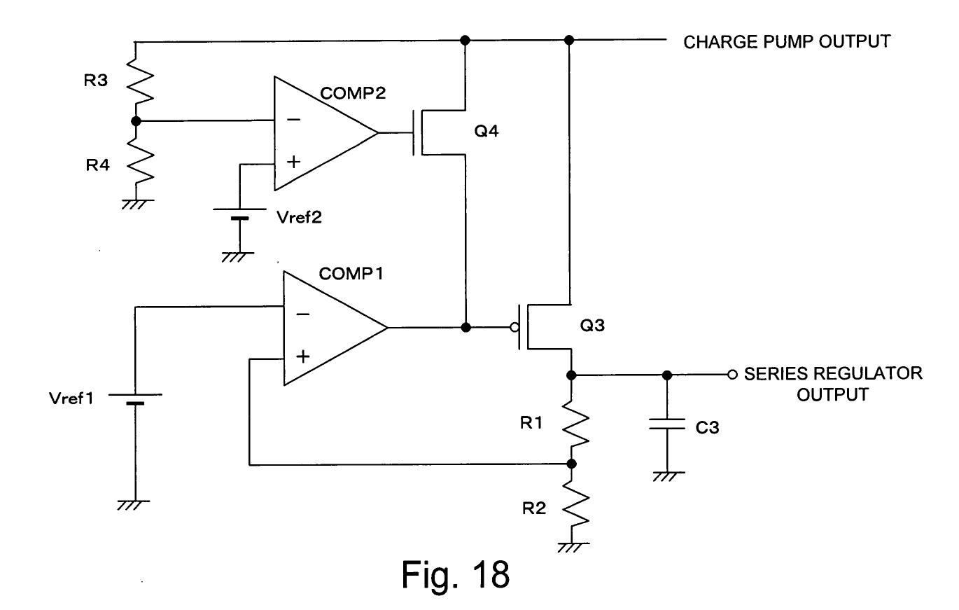

Description will be given next of the voltage monitoring circuit 20 and a specific example of a circuit operable to restrict the current in the series regulator 12 by the voltage monitoring circuit 20 with reference to FIG. 18.

The transistor Q3 and a series circuit of the resistors R1 and R2 are inserted between the output of the charge pump and ground. The reference voltage Vref1 is fed to the inverting input terminal of the comparator COMP1. The connection point between the resistors R1 and R2 is connected to the non-inverting input terminal. The output end of the comparator COMP1 is connected to the gate of the transistor Q3. The connection point between the transistor Q3 and the resistor R1 is connected to the output end. To the output end, one end of the capacitor C3, whose other end is connected to ground, is also connected. The series regulator 12 is thus configured.

The output of the charge pump 10 is connected to ground via resistors R3 and R4. The connection point between the resistors R3 and R4 is connected to the inverting input terminal of a comparator COMP2. A reference voltage Vref2 is fed to the non-inverting input terminal of the comparator COMP2. Therefore, the comparator COMP2 compares the voltage obtained by dividing the output voltage of the charge pump 10 by the resistors R1 and R2 and the reference voltage Vref2. It is to be noted that if the output end voltage is fed back to the inverting input terminal of the op-amp, the output voltage becomes a reference voltage Vref. The output of the comparator COMP2 is fed to the gate of an n-channel transistor Q4. The n-channel transistor Q4 is connected to the output of the charge pump 10 at one end and to the gate of the transistor Q3 at the other end. The voltage monitoring circuit 20 is thus configured.

If the output voltage of the charge pump 10 falls below the predetermined value (Vref 2), the output of the comparator COMP2 goes H. Then, the transistor Q4 turns on. A current is supplied from the transistor Q4 to the gate of the transistor Q3. Consequently, the amount of drain current in the transistor Q3 diminishes. As a result, the amount of current is restricted in the series regulator 12.

It is to be noted that since the comparator COMP1 produces a current output in this example, a current signal is also used to restrict the operating current of the series regulator 12. However, if the operating current of the series regulator 12 can be substantially restricted, a voltage signal may also be employed. Alternatively, a resistor maybe inserted, for example, to restrict the current.

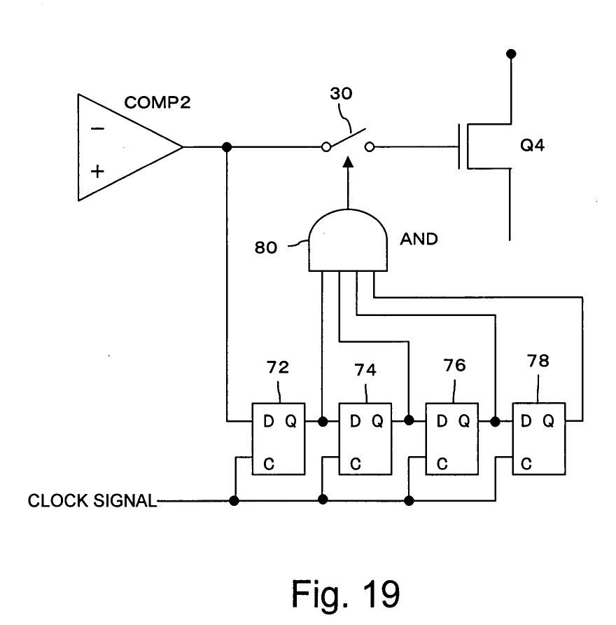

Alternatively, it may be chosen not to operate the voltage monitoring circuit 20 if the output voltage of the charge pump 10 drops due to a pulse current shorter than a predetermined period of time as described above. The circuit intended for this purpose is shown in FIG. 19.

The output of the COMP2 is also fed to the data input terminal of a flip-flop 72. The output terminal of this flip-flop 72 is connected to the data input terminal of a flip-flop 74. The output terminal of the flip-flop 74 is connected to the data input terminal of a flip-flop 76. The output terminal of the flip-flop 76 is connected to the data input terminal of a flip-flop 78. A predetermined clock signal is commonly fed to the clock input terminals of the flip-flops 72 to 78. Therefore, the flip-flop 72 is set to H by the first rising edge of the clock signal after the rising edge of the output of the comparator COMP2. Then, the flip-flops 74 to 78 are set to H in succession. The flip-flops 72 to 78 are all set to H during four clocks of the clock signal.

The data output terminals of the flip-flops 72 to 78 are input to a four-input AND gate 80. The on/off operation of a switch SW2, provided between the output end of the comparator COMP2 and the gate of the transistor Q4, is controlled by the output of this AND gate 80. The switch SW2 is turned on when the output of the AND gate 80 goes H.

In this configuration, the switch SW2 turns on to restrict the current in the series regulator 12 only if the output of the comparator COMP2 remains H until four clocks elapse after the output of the COMP2, i.e., the output of the voltage monitoring circuit 20, goes H.

This allows the series regulator 12 to remain operational even in the presence of a short, mustache-like voltage drop in the output of the charge pump 10.

In particular, it is preferred that the circuit in FIG. 19 be provided separately from the circuit in FIG. 17 intended for the startup so that only the circuit in FIG. 17 is operated at startup and that the circuit in FIG. 19 is put into operation afterwards. In this case, the time of the timer (flip-flops 72 to 78) is preferably shorter than that of the timer 32 in FIG. 17. As for the circuit in FIG. 19, on the other hand, it is preferred that the output be disabled because the occurrence of a large current longer than a predetermined period of time may lead to a short circuit.

While the illustrative and presently preferred embodiment of the present invention has been described in detail herein, it is to be understood that the inventive concepts may be otherwise variously embodied and employed and that the appended claims are intended to be construed to include such variations except insofar as limited by the prior art.

1. A power supply circuit comprising:
a charge pump operable to charge a capacitor to a predetermined voltage and thereafter vary the voltage at one end of the charged capacitor to produce at the other end thereof a voltage shifted in response to the variation; and
a voltage conversion circuit operable to convert the output of the charge pump to a voltage based on the comparison with a predetermined reference voltage, the voltage conversion circuit outputting the converted voltage as the supply voltage of another circuit, wherein the operating current of the voltage conversion circuit is restricted so that the output voltage of the charge pump is prevented from varying over a predetermined value.

2. The power supply circuit of claim 1, wherein the voltage conversion circuit is a series regulator that includes:
an op-amp operable to compare the output voltage or the voltage proportional to the output voltage with the reference voltage;
an output transistor that operates in response to the output of the op-amp; and
resistors operable to convert the operating current of the output transistor to the output voltage.

3. The power supply circuit of claim 1, further comprising:
a monitoring circuit operable to monitor the output voltage of the charge pump, wherein
the operating current of the voltage conversion circuit is restricted in response to the output of the monitoring circuit.

4. The power supply circuit of claim 3, wherein the monitoring of the output voltage of the charge pump by the monitoring circuit is restricted to only a predetermined period of time from the startup.
